(19) United States
(12) Patent Application Publication
(10) Pub. No.: US 2014/0284862 A1
(43) Pub. Date: Sep. 25, 2014

(54) JAWS AND ADAPTER ASSEMBLY FOR A MACHINING SYSTEM

(71) Applicants: John Bettencourt, Fremont, CA (US); Sam Raha, Fremont, CA (US)

(72) Inventors: John Bettencourt, Fremont, CA (US); Sam Raha, Fremont, CA (US)

(21) Appl. No.: 14/205,477

(22) Filed: Mar. 12, 2014

Related U.S. Application Data
(60) Provisional application No. 61/804,811, filed on Mar. 25, 2013.

(51) Int. Cl. B25B 1/24; B25B 1/02

(52) U.S. Cl. CPC B25B 1/2452; B25B 1/2405; B25B 1/02
USPC 269/282; 269/280; 29/426.2

(57) ABSTRACT

A jaws apparatus and method for using the jaws apparatus within a vise is described herein. A jaws apparatus may include a fixed jaw secured to the vise through an adapter. The adapter may have an adapter contact face and the fixed jaw may have a jaw contact face in slidable engagement with the adapter contact face. The adapter contact face may be comprised of a first physical material and the jaw contact face comprised of a second physical material. The first physical material and the second physical material may have substantially similar mechanical properties. The jaws apparatus may further include a movable jaw secured to a movable portion of the vise.

### CROSS-REFERENCE TO RELATED APPLICATIONS

This application claims priority under 35 U.S.C. 119(e) to U.S. Provisional Application No. 61/804,811, filed on Mar. 25, 2013, and entitled, “JAWS AND ADAPTER ASSEMBLY FOR A MACHINING SYSTEM,” which application is hereby incorporated by reference in its entirety as if set forth herein.

### TECHNICAL FIELD

Example embodiments relate to vise jaws used in a precision machining process. More specifically, example embodiments relate to a vise jaws and adapter assembly, and a method of using the same, which reduce or eliminate surface irregularities on the vise.

### BACKGROUND

Many precision machining vises use so-called “soft jaws,” which may be milled to conform to the surface of the workpiece that they are to hold. Because soft jaws are milled to conform to specific workpieces, soft jaws must be removed from the vise and replaced with a new set of soft jaws before the vise can be used with other types of workpieces. It may be time-consuming to switch out soft jaws between each run. Accordingly, there exists a general need to enable quick removal of soft jaws.

Further, it is important that workpieces be machined within strict tolerances. One complicating factor for maintaining such strict tolerances is a tendency for wear to occur at the vise or soft jaws when the technician or machinist removes the soft jaws from the vise. The movement of the soft jaws back and forth on the vise during removal of the soft jaws may mar the vise surface and the accuracy of the vise assembly may deteriorate. Therefore, there exists the further general need to allow soft jaws to be moved from the vise while minimizing friction and keeping particles off the vise itself.

### BRIEF DESCRIPTION OF THE DRAWINGS

FIGS. 1 and 2 are diagrams of a system in which some example embodiments may be implemented.

FIG. 3 is a diagram of a soft jaw bolted to an adapter in accordance with some embodiments.

FIG. 4 is a diagram of a first step of a removal of the soft jaw in accordance with some embodiments.

FIG. 5 is a diagram of an adapter in the system after the soft jaw has been removed in accordance with some embodiments.

FIG. 6-8 are views of a soft jaw attached to an adapter in accordance with some embodiments.

FIG. 9 is a three-view drawing of an adapter in accordance with some embodiments.

FIG. 10 is a three-view drawing of a soft jaw in accordance with some embodiments.

FIG. 11 is a diagram of a process for removing a soft jaw from an adapter in accordance with some embodiments.

FIG. 12 is a flow diagram of a process for removing a soft jaw from an adapter in accordance with some embodiments.

### DETAILED DESCRIPTION

The following description is presented to enable any person skilled in the art to create and use a soft jaw apparatus. Various modifications to the example embodiments herein will be readily apparent to those skilled in the art, and the principles defined herein may be applied to other embodiments and applications without departing from the spirit and scope of the present disclosure. Moreover, in the following description, numerous details are set forth for the purpose of explanation. However, one of ordinary skill in the art will realize that the present disclosure might be practiced without the use of these specific details. Identical reference numerals may be used to represent different views of the same item in different drawings. The present disclosure is not intended to be limited to the example embodiments shown herein, but is to be accorded the widest scope consistent with the principles and features disclosed herein.

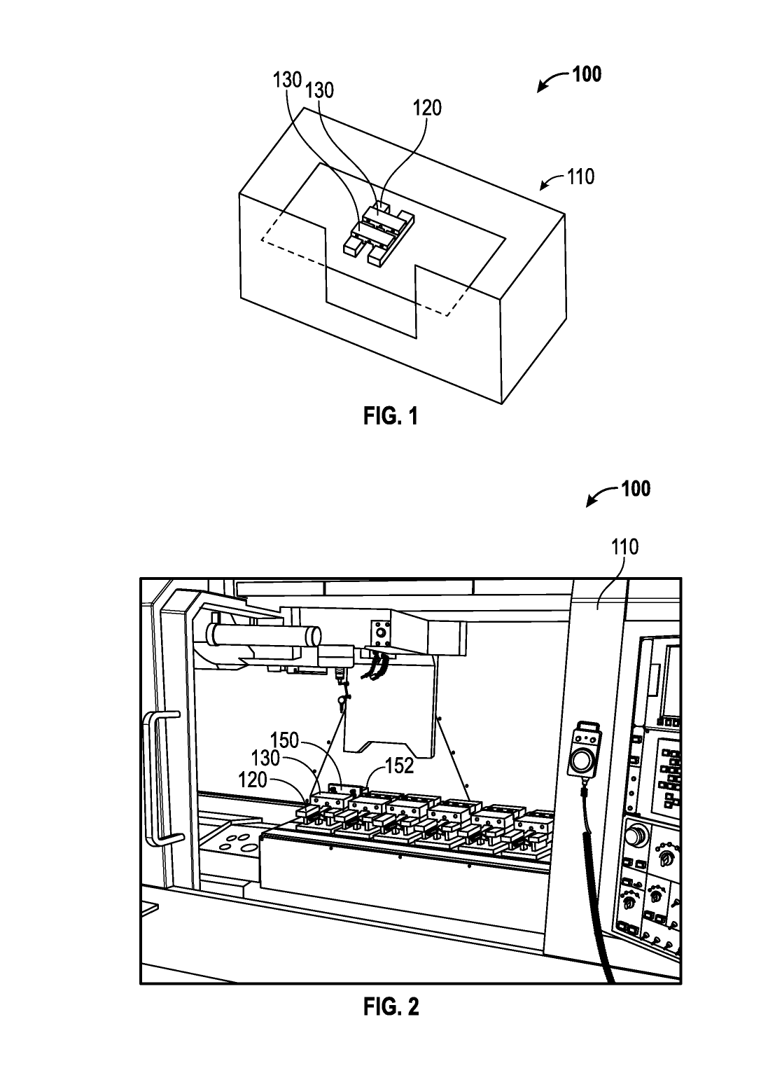

FIG. 1 is a diagram of a system 100 in which some example embodiments may be implemented. The system 100 includes a computer numerical control (CNC) machine 110. In the context of example embodiments, the CNC machine 110 may be used to control the milling of workpieces, for example automotive parts or other metallic parts.

In some embodiments, an operator may use the CNC machine 110 to control operations of a vise to hold a workpiece (not shown in FIG. 1) while the workpiece is milled. The moveable portions 130 of the vise 130 may mount on rails 120. In some embodiments, the CNC machine 110 may control the cutting and completion of the machining operation on the workpiece.

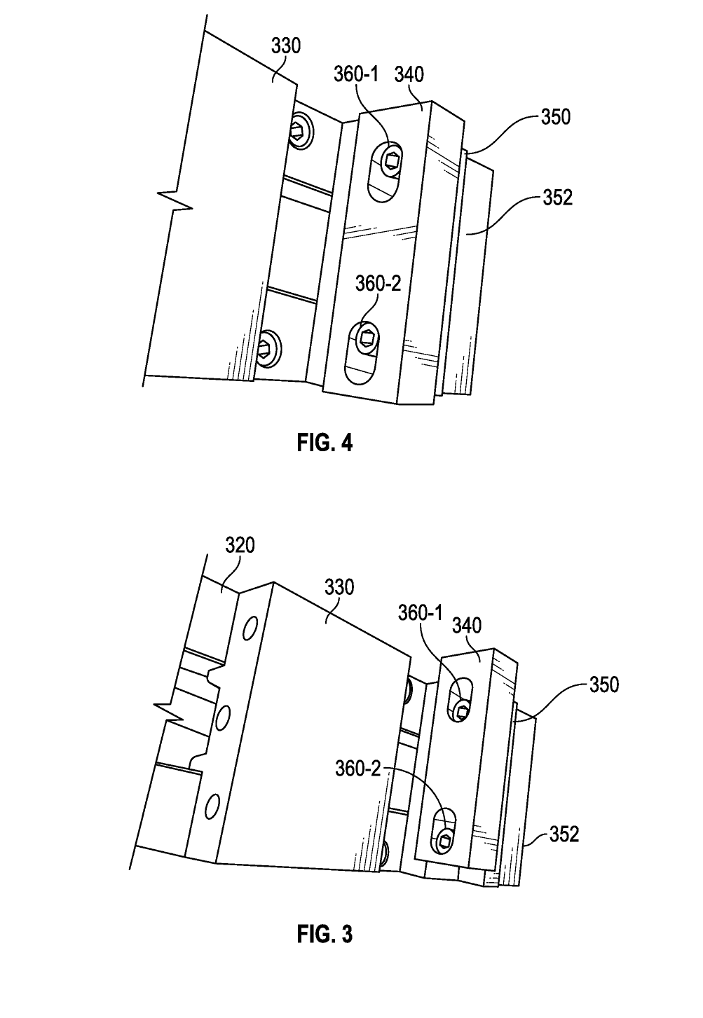

FIG. 2 is a second diagram of a system 100 in which some example embodiments may be implemented. In addition to the CNC machine 110, and rails 120 holding the moveable portions 130 of the vise, an adapter 150 may be included, through which a fixed jaw (not shown in FIG. 2) is attached to a non-moveable portion 152 of the vise as described in more detail below with respect to FIG. 3-12. A similar adapter may be included, through which a moveable jaw is attached to the moveable portions 130 of the vise.

An operator may remove jaws from the system 100 each time a new type of workpiece is going to be produced in the system 100. The removal process may be time-consuming. Further, the movement of the jaws during removal may adversely affect the moveable portion 130 and fixed portion 152 of the vise because of the physical phenomenon of “galling.” Further still, the jaws themselves may be harmed during the machining process by galling.

Galling may be a result of two different metals (for example an aluminum jaw and a steel vise) moving against each other. Irregularities may be formed in the aluminum jaw as the aluminum jaw rubs back and forth against the steel vise. The steel vise may already contain burrs formed from the previous friction between the aluminum jaw and steel vise. The galling, if not removed/cleaned after every jaw change may result in diminished accuracy of the parts being machined.

Example embodiments may use an adapter 150 placed between a fixed jaw and a fixed portion 152 of the vise to reduce or eliminate galling to protect the vise from damage, and to allow for easier removal of soft jaws between milling jobs. Such an adapter 150 may be placed as shown in FIG. 3-8. While FIG. 2 shows an adapter 150 fixedly attached to the fixed portion 152 of the vise, it will be understood that a second adapter (not shown in FIG. 2) may be fixedly attached to the moveable portion 130 of the vise.

With reference to FIG. 3-5, by using the adapter 350 that is also made of aluminum (like the jaw 340) galling and resulting surface irregularities are reduced or eliminated, because the surfaces rubbing against each other are both made of aluminum. While FIG. 3-5 shows one jaw 340 fixedly attached to the fixed vise portion 352 through the adapter 350, it will be understood that a corresponding jaw may be fixedly attached to the moveable vise portion 330. Using an aluminum adapter 350 along with the aluminum jaw 340 in accordance with example embodiments significantly increases the life/use of the jaw 340 and the vise portions 130 and 152 (FIGS. 1 and 2) by maintaining a uniform jaw surface, which results in many more accurate machined parts compared to some current systems in which jaws are affixed directly to the steel vise portions 139 and 152. However, embodiments are not limited to an aluminum adapter 350 or jaw 340, and some embodiments may include an adapter 350 or jaw 340 is made of an aluminum alloy. The jaw 340 may be fixedly attached to the adapter 350 by bolts 360-1 and 360-2.

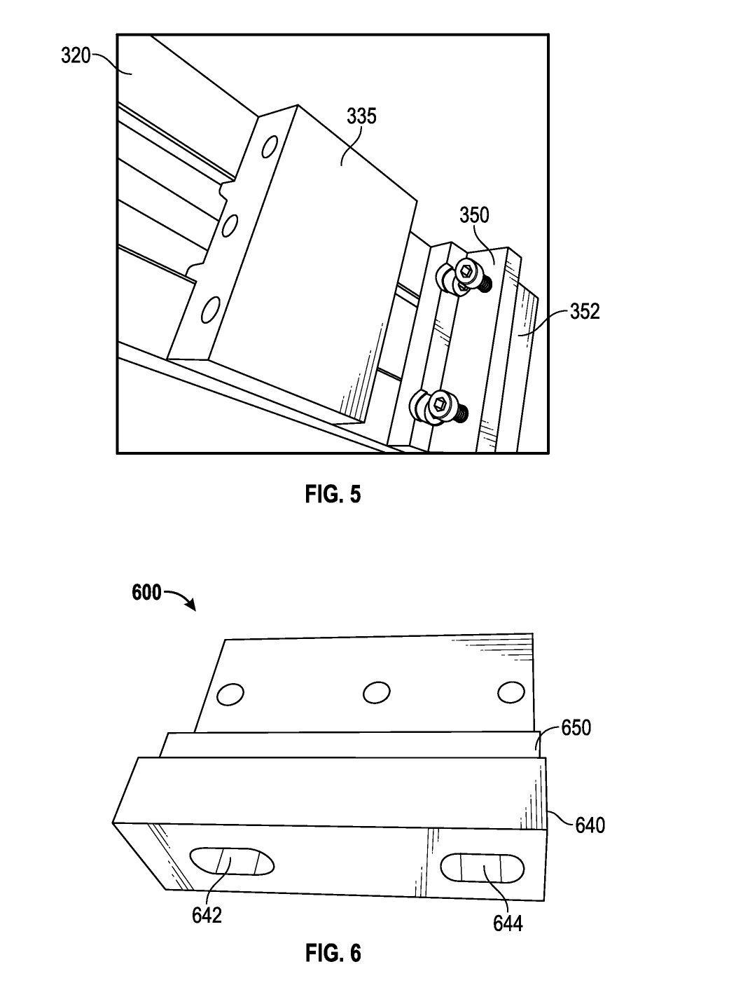

FIG. 4 is a second view of the adapter 350 and the jaw 340. In FIG. 4, an operator may have taken a step toward removing the jaw 340 from the adapter by loosening the bolts 360-1 and 360-2 and sliding the jaw 340 to the left. FIG. 5 is a view of the adapter 350 from which the fixed jaw has been removed in accordance with some embodiments.

With reference to FIG. 6-8, a soft jaw and adapter assembly 600 is shown. One soft jaw 640 of a pair of soft jaws is shown for clarity. The soft jaw 640 may be a rectangular aluminum bars. The soft jaw 640 may be operable to serve as the fixed jaw 340 (FIG. 3-5). In some embodiments, the dimensions of the bar may be 1¼″×2″×6″. The soft jaw 640 may have clearance slots 642, 644 machined into the soft jaw 640 to accommodate hex head bolts (not shown in FIG. 6). An adapter 650 may mount the fixed soft jaw 640 onto a fixed portion 152 (FIG. 2) of a precision vise. In some embodiments, the hex head bolts are ½-13 hex head bolts. An adapter may also mount the other soft jaw of the pair of soft jaws (not shown in FIG. 6-8) onto a moveable portion 130 of the precision vise (FIGS. 1 and 2).

The adapter 650 may have an adapter contact face (not shown in FIG. 6-8). The soft jaw 640 may have a jaw contact face in slidable engagement with the adapter contact face. The adapter contact face may be comprised of a first physical material and the jaw contact face may be comprised of a second physical material. The first physical material and the second physical material may have substantially similar mechanical properties. The first physical material and the second physical material may have substantially similar ductile properties. The first physical material and the second physical material may have substantially similar crystalline structures. The first physical material and the second physical material may be substantially the same material.

The adapter 650 may place a buffer between the fixed jaw and the fixed portion 152 of the steel vise. The adapter 650 may be a fixture that can be used for multiple jobs/runs of machined parts. However, one may choose to change out an individual jaw 640 of the set of two jaws.

The amount of time used to remove or change out the soft jaw and adapter assembly may be reduced in example embodiments, because a technician or user can utilize the clearance slots 642, 644 and turn the bolts 360-1, 360-2 (FIG. 3-5) only partially (e.g., ¼ turn) to remove the fixed jaw 640. Accordingly, changeover time may be reduced substantially, for example by around 75%. Further, current methods and systems in which a bolt attaching the soft jaw to the vise must be completely removed may require more force, and therefore more friction, to remove the soft jaws. The surface of portions 130, 152 of the vise (FIG. 1-2) may become marred or distorted, and dust may be created by galling, because of this increased friction and rubbing. On the other hand, in example embodiments, the soft jaw slides a much shorter distance, and less force is used to detach the jaw.

In some example embodiments, the adapter may be replaced upon becoming marred.

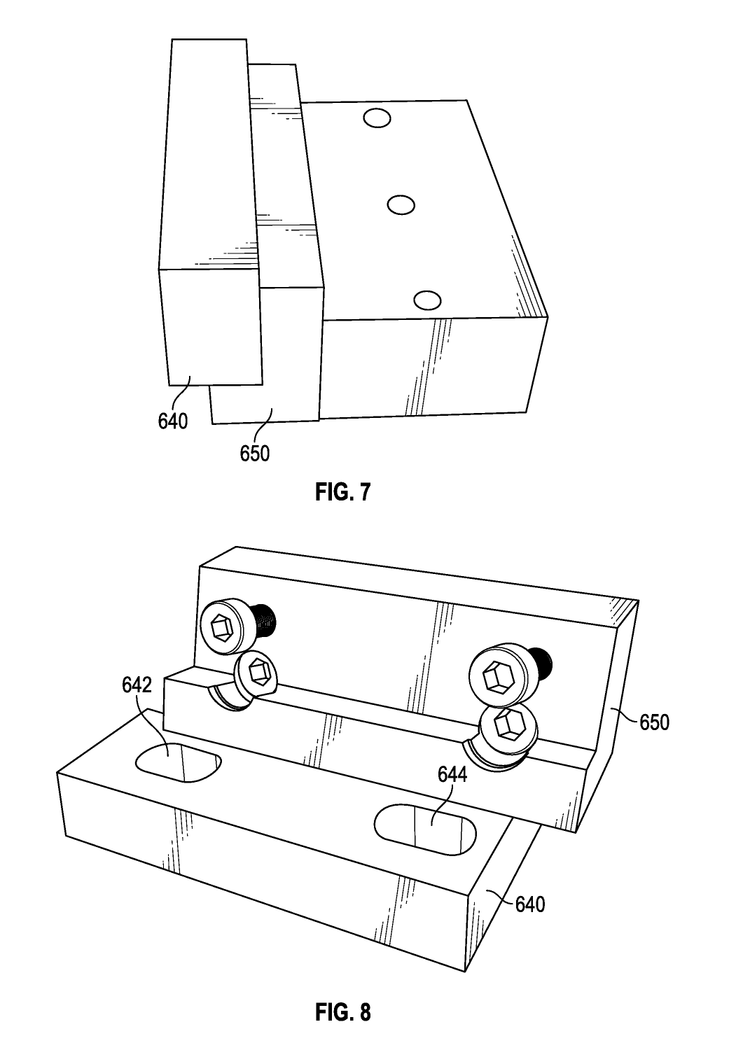

FIG. 7 is a side view of the adapter 650 and fixed soft jaw 640 assembly. FIG. 8 is a view of the adapter 650 disassembled from the fixed soft jaw 640.

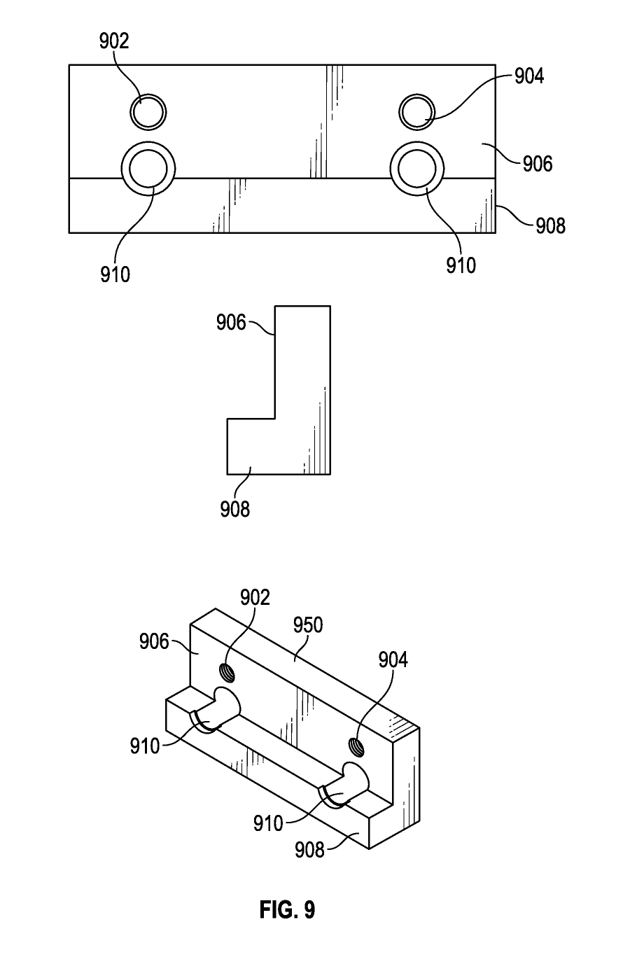

FIG. 9 is a three-view drawing of a machining jaws adapter 950 in accordance with some embodiments. The adapter 950 may be operable as an adapter 350 (FIG. 3-8). The adapter 950 may include first bolt apertures 902 and 904 in a first surface 906. First bolt apertures 902 and 904 may be sized so that first bolts 360-1 and 360-2 (FIG. 3-5) may sit recessed within first bolt apertures 902 and 904 such that the first surface 906 presents a flush surface to a facing surface of the soft jaw (not shown in FIG. 9).

The adapter 950 may further include a second surface 908 at an angle to the first surface 906. In some embodiments, the first surface 906 and the second surface 908 are perpendicular to each other such that the second surface 908 acts as a support surface upon which a downward surface of the jaw (not shown in FIG. 9) rests. The second surface 908 may act as an alignment surface for vertical alignment of the jaw during insertion or removal of the jaw.

The adapter 950 may further include second bolt apertures 910 arranged separately from the first bolt apertures 902 and 904 in the first surface 906 and passing through a portion of the second surface 908. The adapter 950 may include first bolts 260-1 and 260-2 (FIG. 7) passing through the first bolt apertures 902 and 904 to affix the adapter 950 to a vise (not shown in FIG. 9).

The adapter 950 may include second bolts (not shown in FIG. 9) passing through second bolt apertures 910 and through a portion of the second surface 908 to affix the adapter 950 to a vise jaw, for example a soft jaw as discussed above. The second bolts may be hex head bolts. The adapter 950 may be a different material than the vise. The adapter 950 may be comprised of aluminum.

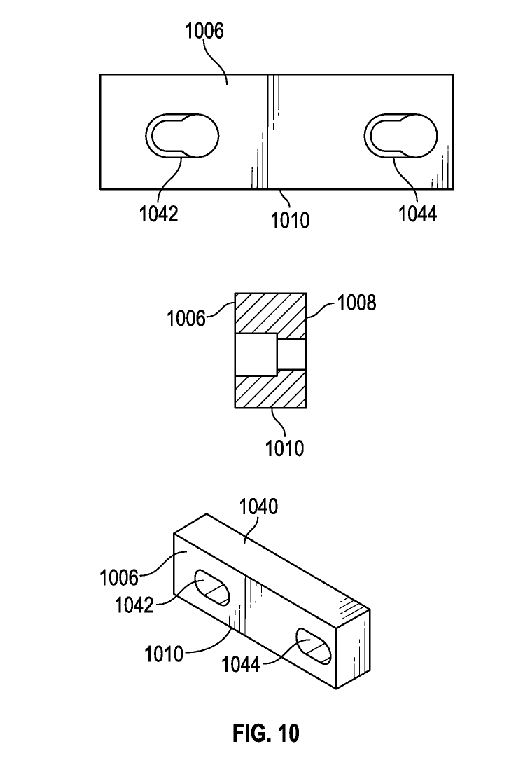

FIG. 10 is a three-view drawing of a soft jaw 1040 in accordance with some embodiments. The soft jaw 1040 may be suitable for use as the jaw 340 (FIG. 3-4, or 6-8). The soft jaw 1040 may be comprised of aluminum. The soft jaw 1040 may include two apertures 1042 and 1044 in a first surface 1006. The apertures 1042 and 1044 may be configured to receive second bolts as described above with respect to FIG. 9. The apertures 1042 and 1044 may be key hole apertures. The apertures 1042 and 1044 may be wide enough to allow passage therethrough of the second bolt heads during insertion and removal of the soft jaw 1040.

The heads of the second bolts may be groove mounted against a shoulder defined by the jaw at one end of the each of the apertures 1042 and 1044. The heads of the second bolts may slide to the other side of each of the apertures 1042 and 1044 during an installation or uninstallation operation to remove the soft jaw 1040 from the adapter 950 (FIG. 9). The soft jaw 1040 may have a second surface 1008 abutting the first surface 906 (FIG. 9) of the adapter 950. The second surface 1008 may be opposite first surface 1006. The soft jaw 1040 may have a third (downward-facing) surface 1010 to abut the second surface 908 of the adapter 950 (FIG. 9) and to slidably engage the adapter 950.

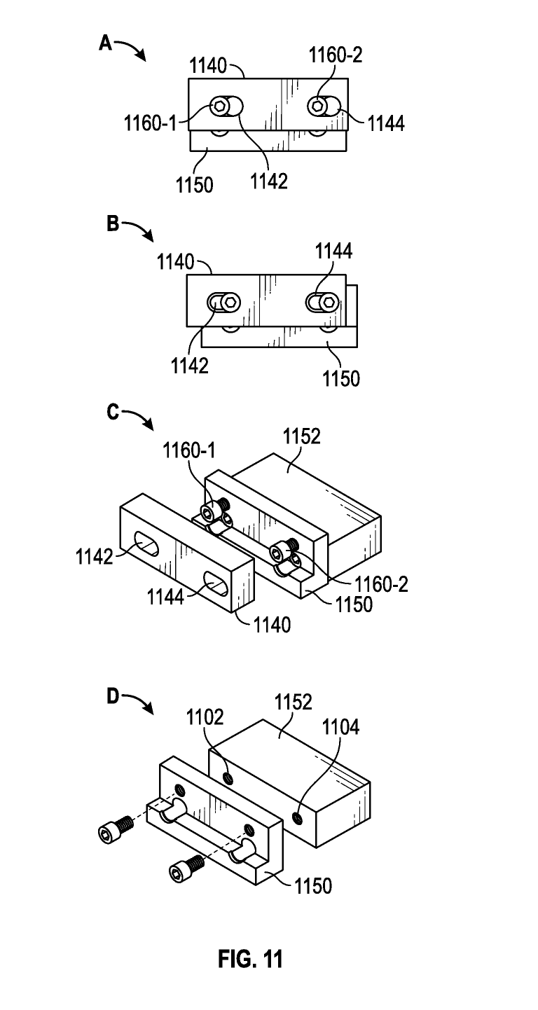

FIG. 11 is a diagram of a process for removing a soft jaw from an adapter in accordance with some embodiments. In A, bolts 160-1, 11650-2 fastening the soft jaw 1140 to the adapter 1150 may be loosened. The soft jaw 1140 may be suitable to operate as the jaw 340 (FIG. 3-4, or 6-8) or the jaw 1040 (FIG. 10). The adapter 950 may be operable as an adapter 350 (FIG. 3-8) or the adapter 950 (FIG. 9). The bolts 1160-1, 1160-2 may be loosened by less than a full turn, for example, one-quarter turn. The bolts 1160-1, 1160-2 may be hex head bolts. The bolts 1160-1, 1160-2 may be loosened with, for example, an Allen™ wrench.

In B, the soft jaw 1140 may be slid until the bolt heads contact the other side of the keyhole apertures 1142 and 1144. The key hole apertures 1142, 1144 may be operable to serve as the apertures 1042 and 1044 (FIG. 10). For example, a fixed vise jaw may be slidably engaged over a surface of the adapter 350 until the bolts engage a second end of the keyhole apertures 1142 and 1144. The third surface 1010 and the second surface 1008 (FIG. 10) of the soft jaw 1140 may slide against the first surface 906 and the second surface 908 of the adapter 950 (FIG. 9) during insertion or removal of the soft jaw 1140. However, at least because the soft jaw 1140 and the adapter 950 may comprise the same or substantially the same material, galling may be reduced or eliminated.

In C, a third surface 1010 (FIG. 10) of the soft jaw 1140 may have rested upon or abutted the second surface 908 (FIG. 9) of the adapter 950. A second surface 1008 (FIG. 10) may have abutted the first surface 906 (FIG. 9) of the adapter 950. The soft jaw 1140 may be removed from the base 1150 through, for example, a lifting operation.

In operation D, the adapter 1150 may be removed from the fixed portion 1152 of the vise through removal of bolts 1160-1 and 1160-2. Operation D may be performed relatively rarely or infrequently compared to operations A-C because soft jaw 1140 may be switched on and off the system 100 several times per day whereas the adapter 1150 may be seldom removed, for example only when the operator visibly notices wear at the adapter 1150.

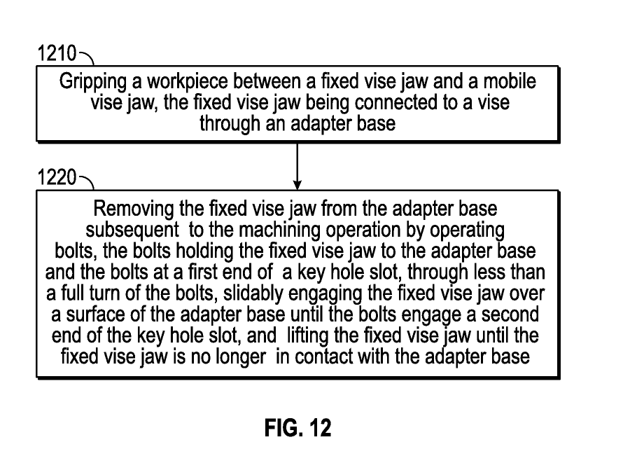

FIG. 12 is a flow diagram of a process for removing a soft jaw from an adapter in accordance with some embodiments. In operation 1210, a machining jaws apparatus as described previously may grip a workpiece between a fixed vise jaw and a mobile vise jaw of the machining apparatus. The fixed vise jaw may be connected to rails 120 (FIG. 1) through an adapter 350 (FIG. 3-8).

In operation 1220, the fixe vise jaw may be removed from the adapter 350 by operating bolts as described above with respect to element A in FIG. 11, sliding the fixed vise jaw as described above with respect to element B in FIG. 11, and lifting the fixed vise jaw away from the adapter as describe above in element C of FIG. 11.

Example embodiments allow soft jaws for a vise in a machining system to be unbolted quickly with less movement so that users can swap out soft jaws more often according to needs of small-run machine shops without damaging the vise. Tolerances may be maintained for both small and large shops because less marring may occur at the vise. Friction caused by soft jaw removal may be reduced and less galling may occur.

Although the present disclosure has been described in connection with some embodiments, it is not intended to be limited to the specific form set forth herein. One skilled in the art would recognize that various features of the described embodiments may be combined in accordance with the present disclosure. Moreover, it will be appreciated that various modifications and alterations may be made by those skilled in the art without departing from the spirit and scope of the present disclosure.

In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A jaw apparatus for a vise, the jaw apparatus comprising:
a fixed jaw secured to the vise through an adapter, the adapter having an adapter contact face and the fixed jaw having a jaw contact face in slidable engagement with the adapter contact face, the adapter contact face comprised of a first physical material and the jaw contact face comprised of a second physical material, the first physical material and the second physical material having substantially similar mechanical properties; and
a movable jaw secured to a movable portion of the vise.

2. The jaw apparatus of claim 1, wherein the first physical material and the second physical material have substantially similar ductile properties.

3. The jaw apparatus of claim 2, wherein the first physical material and the second physical material have substantially similar crystalline structures.

4. The jaw apparatus of claim 3, wherein the first physical material and the second physical material are substantially the same material.

5. The jaw apparatus of claim 1, wherein the vise is comprised of steel and the adapter and the fixed jaw are comprised of a material softer than steel.

6. The jaw apparatus of claim 5, wherein the adapter and the fixed jaw are comprised of aluminum or an aluminum alloy.

7. The jaw apparatus of claim 1, further comprising:
first attachment bolts passing through first apertures of the adapter to fixedly attach the adapter to the vise;
second attachment bolts passing through second apertures of the adapter to fixedly attach the fixed jaw to the adapter, the second apertures being different from the first apertures.

8. The jaw apparatus of claim 7, wherein the second apertures are key hole apertures.

9. The jaw apparatus of claim 8, wherein the second attachment bolts are hex head bolts.

10. The jaw apparatus of claim 1, further comprising a second adapter secured to the movable jaw, and wherein the movable jaw is fixed to the vise through the second adapter, the second adapter having a second adapter contact face and the movable jaw having a movable jaw contact face in slidable engagement with the second adapter contact face, the second adapter contact face comprised of a third physical material and the movable jaw contact face comprised of a fourth physical material, the third physical material and the fourth physical material having substantially similar mechanical properties.

11. The jaw apparatus of claim 10, wherein the second adapter is comprised of aluminum or an aluminum alloy.

12. A jaw adapter for a vise, comprising:
first bolt apertures in a first surface;
a second surface arranged at an angle to the first surface;
second bolt apertures arranged separately from the first bolt apertures in the first surface and passing through a portion of the second surface;
first bolts passing through the first bolt apertures to affix the jaw adapter to the vise; and
second bolts passing through the second bolt apertures and through a portion of the second surface to affix the jaw adapter to a jaw.

13. The jaw adapter of claim 12, wherein the second bolts are hex head bolts.

14. The jaw adapter of claim 13 wherein the jaw adapter is comprised of a different material from the vise.

15. The jaw adapter of claim 13, wherein the jaw adapter is comprised of aluminum or an aluminum alloy.

16. The jaw adapter of claim 15, wherein the jaw adapter has a jaw adapter contact face and the jaw has a jaw contact face in slidable engagement with the jaw adapter contact face, the jaw adapter contact face comprised of a first physical material and the jaw contact face comprised of a second physical material, the first physical material and the second physical material having substantially similar mechanical properties.

17. The jaw adapter of claim 16, wherein the first physical material and the second physical material have substantially similar ductile properties.

18. The jaw apparatus of claim 17, wherein the first physical material and the second physical material have substantially similar crystalline structures.

19. A method of using a machining jaws apparatus, the method comprising:
gripping a workpiece between a fixed vise jaw and a mobile vise jaw, the fixed vise jaw being connected to a vise through an adapter;
removing the fixed vise jaw from the adapter subsequent to the machining operation by
operating bolts, the bolts holding the fixed vise jaw to the adapter and the bolts at a first end of a key hole slot, through less than a full turn of the bolts,
slidably engaging the fixed vise jaw over a surface of the adapter until the bolts engage a second end of the key hole slot, and
lifting the fixed vise jaw until the fixed vise jaw is no longer in contact with the adapter.

20. The method of claim 19, wherein operating the bolts comprises turning the bolts one-quarter of a full turn.
